(19) United States
(12) Patent Application Publication
(10) Pub. No.: US 2026/0364931 A1
(43) Pub. Date: Nov. 19, 2026

(54) TOOL FOR MANUFACTURING A MULTIPLE DEGREE OF FREEDOM ACOUSTIC ABSORPTION STRUCTURE AND METHOD FOR MANUFACTURING SUCH AN ACOUSTIC ABSORPTION STRUCTURE BY MEANS OF SAID TOOL

(71) Applicant: Airbus Operations SAS, TOULOUSE (FR)

(72) Inventor: Philippe WESSEL, TOULOUSE (FR)

(21) Appl. No.: 19/671,413

(22) Filed: May 8, 2026

(30) Foreign Application Priority Data
May 13, 2025 (FR) FR2505055

(51) Int. Cl. B32B 37/00; B32B 3/12; B32B 7/12; B32B 38/04; B32B 38/18

(52) U.S. Cl. CPC B32B 37/0046; B32B 3/12; B32B 7/12; B32B 38/04; B32B 38/18; B32B 2038/047; B32B 2307/102

(57) ABSTRACT

A tool for manufacturing an MDOF acoustic absorption structure and an associated manufacturing method wherein the tool includes plates including rods extending over a height h1, h2 and made movable with respect to one another by articulation devices. The plates are shaped to receive a honeycomb structure of height h therebetween, the sum of the heights h1 and h2 being equal to the height h. The rods are configured to be inserted into the cells of the honeycomb structure. Each of the rods include radial expansion arrangements configured to lock the position of the honeycomb structure with respect to the tool.

### CROSS-REFERENCES TO RELATED APPLICATIONS

This application claims the benefit of French Patent Application Number FR2505055, filed on May 13, 2025, the entire disclosures of which are incorporated herein by way of reference.

### FIELD OF THE INVENTION

The present application relates to a tool for manufacturing a multiple degree of freedom acoustic absorption structure and to a method for manufacturing such an acoustic absorption structure by means of said tool.

### BACKGROUND OF THE INVENTION

During its operation, an aircraft engine generates noise. This engine is housed in a nacelle, and to attenuate this noise, it is known to place an acoustic absorption structure around the engine in the structure of the nacelle.

As shown in FIG. 1, such an acoustic absorption structure 10 comprises first and second honeycomb structures 20, 30 positioned between an acoustically resistive layer 40 (which is porous, that is to say, perforated) in contact with a medium in which acoustic waves propagate and a reflective layer 50 (which is impermeable, that is to say, non-perforated). This acoustic absorption structure 10 comprises an acoustically resistive porous (that is to say, perforated) partition 60 interposed between the first and second honeycomb structures 20, 30, the first honeycomb structure 20 being interposed between the acoustically resistive layer 40 and the acoustically resistive porous partition 60, and the second honeycomb structure 30 being interposed between the reflective layer 50 and the acoustically resistive porous partition 60. Each honeycomb structure 20, 30 comprises a plurality of cylindrical cells 22, 32 (with a hexagonal base for example), each closed at a first end 24, 34 by the acoustically resistive layer 40 (for the cells 22 of the first honeycomb structure 20) or by the reflective layer 50 (for the cells 32 of the second honeycomb structure 30) and at a second end 26, 36 by the porous partition 60. The cells 22 of the first honeycomb structure 20 are juxtaposed on the cells 32 of the second honeycomb structure 30.

Such an acoustic absorption structure 10 makes it possible to attenuate the low-frequency sound waves at the cells 22 of the first honeycomb structure 20, and also the high-frequency sound waves at the cells 32 of the second honeycomb structure 30. Such an acoustic absorption structure 10 is referred to as a multiple degree of freedom (MDOF), here a double degree of freedom (DDOF), structure.

A current method for manufacturing such an acoustic absorption structure 10 consists of:
a step of fastening, by bonding, the reflective layer 50 to the first end 34 of the second honeycomb structure 30,
a step of fastening, by bonding, the acoustically resistive porous partition 60 to the second end 36 of the second honeycomb structure 30,
a step of fastening, by bonding, the second end 26 of the first honeycomb structure 20 to the acoustically resistive porous partition 60, and
a step of fastening, by bonding, the acoustically resistive layer 40 to the first end 24 of the first honeycomb structure 20.

However, with such a manufacturing method, alignment of the cells 22, 32 of the first and second honeycomb structures 20, 30 is not ensured. Since the optimal acoustic performance of an acoustic absorption structure is only ensured when there is correct alignment of the cells 22, 32 of the first and second honeycomb structures 20, 30, the acoustic absorption structure obtained with such a manufacturing method may be less effective than expected.

An acoustic absorption structure 10 can also be formed from a single honeycomb structure 70, as shown in FIG. 2, comprising a plurality of hexagonal cells 72.

A current method for manufacturing such an acoustic absorption structure 10 consists of:
a step of fastening, by bonding, the reflective layer 50 to a first end 74 of the honeycomb structure 70,
a step of inserting and fastening a cap 80 of hexagonal shape in each cell 72 of the honeycomb structure 70, so as to separate the cells 72 of the honeycomb structure 70 into two parts, the cap 80 consisting of an acoustically resistive porous partition, and
a step of fastening, by bonding, the acoustically resistive layer 40 to a second end 76 of the honeycomb structure 70.

With such a manufacturing method, the first parts of the cells 72 of the honeycomb structure 70 are correctly aligned with the second parts of the cells 72 of the honeycomb structure 70. However, the acoustically resistive porous partition – also known as “septum” – is discontinuous.

With this method, the cap inserted into each cell is fastened to the walls of said cell at a junction zone. The perforated surface of the cap (acoustically resistive porous partition) of each cell is reduced by the presence of the junction zone, and this has an impact on the acoustic performance of the acoustic absorption structure. Furthermore, this manufacturing method is time-consuming.

There is therefore a need for a new method for manufacturing an MDOF acoustic absorption structure, which makes it possible to obtain an MDOF acoustic absorption structure having cells that are correctly aligned with one another and having a septum that is continuous.

### SUMMARY OF THE INVENTION

The present invention aims to propose a solution allowing the manufacture of an MDOF acoustic absorption structure having a continuous porous partition and cells with ensured alignment.

To this end, the invention relates to a tool for manufacturing an acoustic absorption structure from a honeycomb structure comprising a plurality of cells of height h, comprising:
a first plate having a first inner face and a first outer face, and comprising a plurality of first rods extending from the first inner face over a height h1,
a second plate having a second inner face and a second outer face, and comprising a plurality of second rods extending from the second inner face over a height h2,
articulation means connected to the first and second plates,

the first plate being movable with respect to the second plate by means of the articulation means between an open position in which the first and second outer faces are disposed side by side and a closed position in which the first inner face is disposed facing the second inner face; the first and second plates being shaped to receive the honeycomb structure therebetween, the first and second rods being intended to be inserted into the cells of the honeycomb structure; the sum of the heights h1 and h2 being substantially equal to the height h; and each of the first and second rods comprising means for radially expanding said first or second rod.

Advantageously, the use of such a tool makes it possible to maintain correct alignment between the cells of the honeycomb substructures forming the MDOF acoustic absorption structure. In addition, this tool allows the insertion of a continuous porous partition between the honeycomb substructures, and therefore the formation of an MDOF acoustic absorption structure with a continuous septum.

According to another feature, for each first or second rod, the radial expansion means are means for mechanically radially expanding the rod.

According to another feature, for each first or second rod, the radial expansion means comprise a first ring fastened around the rod, a second ring arranged around the rod and a plurality of petals connected to the first and second rings by articulations, the second ring being configured to be movable in translation with respect to the first ring between a first position remote from the first ring in which the petals are in contact with the rod and a second position close to the first ring in which the petals articulate and extend radially in the cell.

According to another feature, for each first or second rod, the radial expansion means comprise a first ring fastened around the rod, a second ring arranged around the rod and at least one elastomer bar connected to the first and second rings, the second ring being configured to be movable in translation with respect to the first ring between a first position remote from the first ring in which the elastomer bar is in contact with the rod and a second position close to the first ring in which the elastomer bar deforms and extends radially in the cell.

According to another feature, for each first or second rod, the radial expansion means are means for fluidically radially expanding the rod.

According to another feature, for each first or second rod, the radial expansion means comprise first and second rings fastened around the rod and a flexible membrane connected to the first and second rings and defining a volume between the first and second rings and the rod, the volume being able to be filled with a pressurized fluid, the membrane being configured to deform and extend radially in the cell when the volume is filled with the pressurized fluid.

According to another feature, the first plate also comprises a plurality of third rods extending from the first inner face over a height h3, the second plate also comprises a plurality of fourth rods extending from the second inner face over a height h4; the third and fourth rods are intended to be inserted into the cells of the honeycomb structure; the sum of the heights h3 and h4 is substantially equal to the height h; each of the third and fourth rods comprise means for radially expanding the third or fourth rod; and the first, second, third and fourth rods are retractable.

According to another feature, the first and second plates are planar.

According to another feature, the first and second plates are curved.

The invention also relates to a method for manufacturing an acoustic absorption structure by means of a tool according to the invention, comprising:
a step of installing the honeycomb structure in the tool such that the first and second rods are inserted into the cells of the honeycomb structure,
a step of maintaining the position of the cells of the honeycomb structure in the tool, by expanding the means for radially expanding the first and second rods,
a step of separating the honeycomb structure into a first honeycomb substructure comprising first cells and a second honeycomb substructure comprising second cells,
a step of fastening a porous partition between the first and second honeycomb substructures,
a step of stopping maintaining the position of the cells of the first and second honeycomb substructures in the tool, by radially retracting the means for radially expanding the first and second rods,
a step of fastening a reflective layer to the second honeycomb substructure, and
a step of fastening an acoustically resistive layer to the first honeycomb substructure.

Advantageously, this manufacturing method makes it possible to obtain an MDOF acoustic absorption structure having a continuous porous partition and cells with correct alignment. This method is advantageously not time-consuming.

According to another feature, the method comprises, prior to the step of fastening a porous partition, a step of drilling drainage holes in at least one of the first or second honeycomb substructures.

### BRIEF DESCRIPTION OF THE DRAWINGS

Further features and advantages will become apparent from the following description of the invention, which is given by way of example only, with reference to the appended drawings, in which:

FIG. 1 is a perspective view of an unassembled DDOF acoustic absorption structure that has already been presented, illustrating one embodiment of the prior art,

FIG. 2 is a perspective view of an unassembled DDOF acoustic absorption structure that has already been presented, illustrating another embodiment of the prior art,

FIG. 3 is a flowchart of the steps of a method for manufacturing a DDOF acoustic absorption structure, illustrating one embodiment of the invention,

FIG. 4a is a perspective view of a honeycomb structure intended to be used for the manufacture of an acoustic absorption structure by means of the manufacturing method in FIG. 3,

FIG. 4b is a perspective view of a tool for the manufacture of a DDOF acoustic absorption structure, illustrating one embodiment of the invention,

FIG. 5 is a sectional view of a tool, in the closed position, for the manufacture of a DDOF acoustic absorption structure, during a step of the manufacturing method in FIG. 3,

FIG. 6a is an enlarged sectional view of part of a tool, with the locking means in the rest position, for the manufacture of a DDOF acoustic absorption structure, in a first configuration of a step of the manufacturing method in FIG. 3,

FIG. 6b is an enlarged sectional view of part of a tool, with the locking means in the activation position, for the manufacture of a DDOF acoustic absorption structure, in a first configuration of a step of the manufacturing method in FIG. 3,

FIG. 7a is an enlarged sectional view of part of a tool, with the locking means in the rest position, for the manufacture of a DDOF acoustic absorption structure, in a second configuration of a step of the manufacturing method in FIG. 3,

FIG. 7b is an enlarged sectional view of part of a tool, with the locking means in the activation position, for the manufacture of a DDOF acoustic absorption structure, in a second configuration of a step of the manufacturing method in FIG. 3,

FIG. 8a is an enlarged sectional view of part of a tool, with the locking means in the rest position, for the manufacture of a DDOF acoustic absorption structure, in a third configuration of a step of the manufacturing method in FIG. 3,

FIG. 8b is an enlarged sectional view of part of a tool, with the locking means in the activation position, for the manufacture of a DDOF acoustic absorption structure, in a third configuration of a step of the manufacturing method in FIG. 3,

FIG. 9 is a sectional view of a tool, in the closed position, for the manufacture of a DDOF acoustic absorption structure, during a step of the manufacturing method in FIG. 3,

FIG. 10 is a sectional view of a tool, in the open position, for the manufacture of a DDOF acoustic absorption structure, during a step of the manufacturing method in FIG. 3,

FIG. 11 is a sectional view of a tool, in the closed position, for the manufacture of a DDOF acoustic absorption structure, during a step of the manufacturing method in FIG. 3,

FIG. 12 is a perspective view of an unassembled DDOF acoustic absorption structure, during a step of the manufacturing method in FIG. 3,

FIG. 13 is a flowchart of the steps of a method for manufacturing an MDOF acoustic absorption structure, illustrating one embodiment of the invention,

FIG. 14 is a sectional view of a tool, in the closed position, for the manufacture of an MDOF acoustic absorption structure, during a step of the manufacturing method in FIG. 13,

FIG. 15 is a sectional view of a tool, in the closed position, for the manufacture of an MDOF acoustic absorption structure, during a step of the manufacturing method in FIG. 13,

FIG. 16 is a sectional view of a tool, in the closed position, for the manufacture of an MDOF acoustic absorption structure, during a step of the manufacturing method in FIG. 13,

FIG. 17 is a flowchart of the steps of a method for manufacturing an MDOF acoustic absorption structure, illustrating one embodiment of the invention, and

FIG. 18 is a sectional view of a tool, in the closed position, for the manufacture of a DDOF acoustic absorption structure, during a step of the manufacturing method in FIG. 3, illustrating one embodiment of the invention.

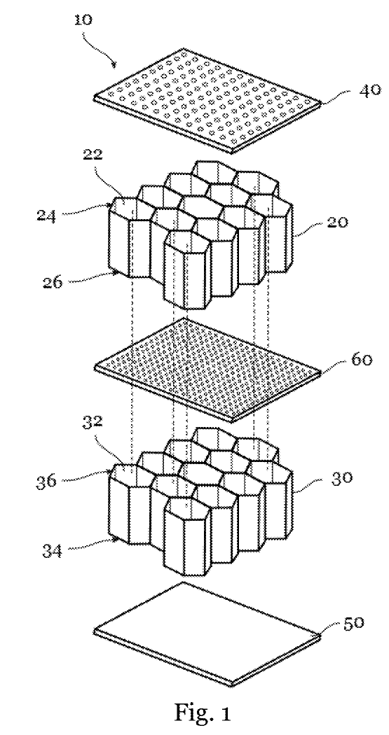

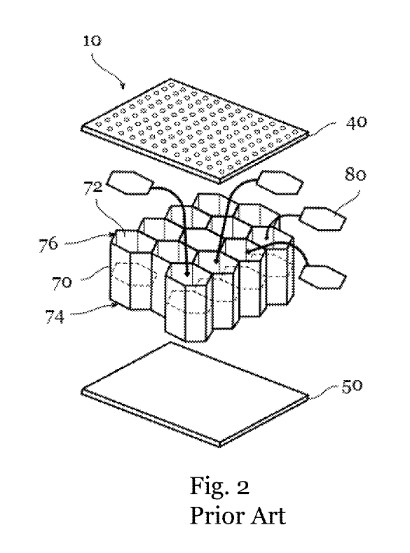

### DETAILED DESCRIPTION OF THE PREFERRED EMBODIMENTS

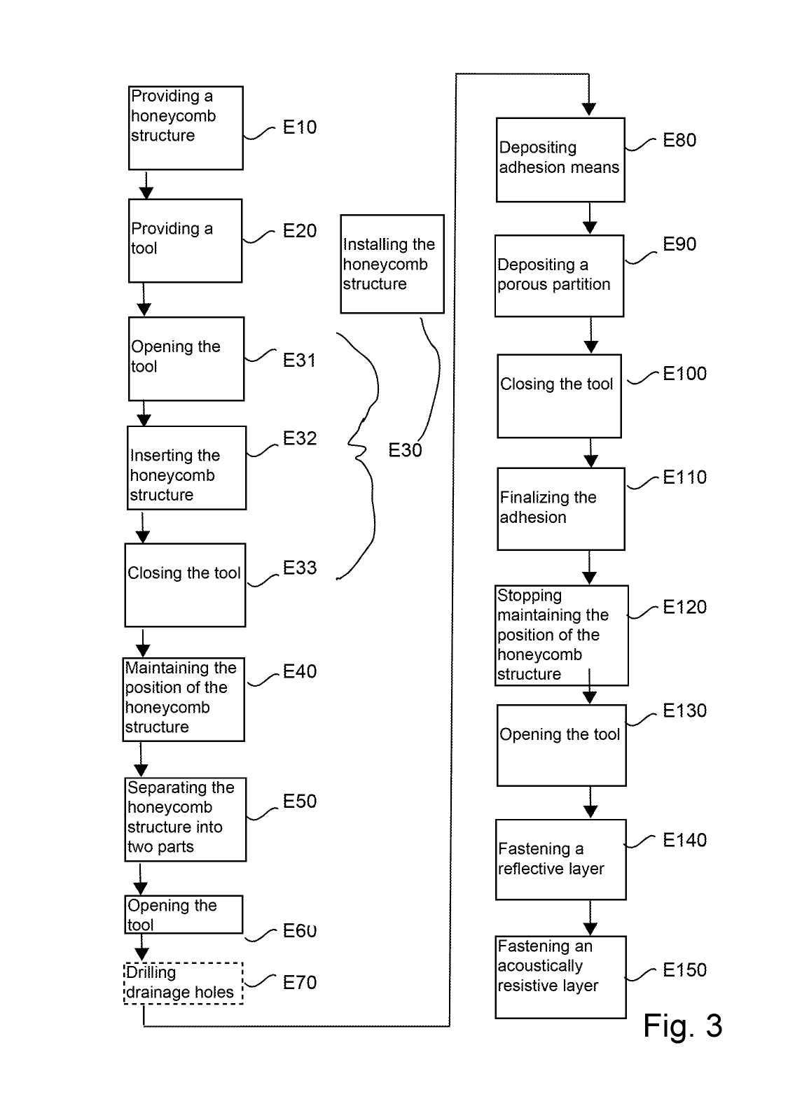

FIG. 3 shows the different steps of the method for manufacturing a DDOF acoustic absorption structure.

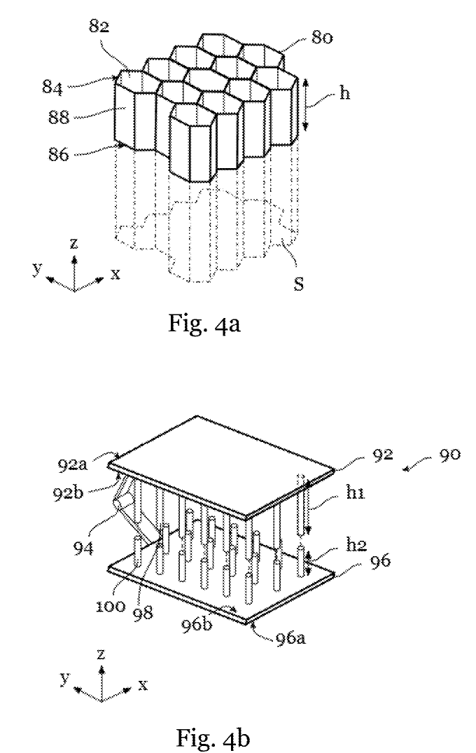

The method comprises a step E10 of providing a honeycomb structure 80, shown in FIG. 4a, comprising a plurality of cells 82 which are delimited by walls 88 and open out at first and second ends 84, 86 of the honeycomb structure 80. The cells 82 have substantially all the same dimensions and have the same volume. The honeycomb structure 80, and therefore each cell 82, has a height h (along a vertical axis z). The height h of the honeycomb structure 80 corresponds substantially to the height of the DDOF acoustic absorption structure obtained by the manufacturing method. The honeycomb structure 80 extends over a surface S (along the horizontal axes x and y, which are orthogonal to the vertical axis z).

The method also comprises a step E20 of providing a tool 90 for the manufacture of a DDOF acoustic absorption structure.

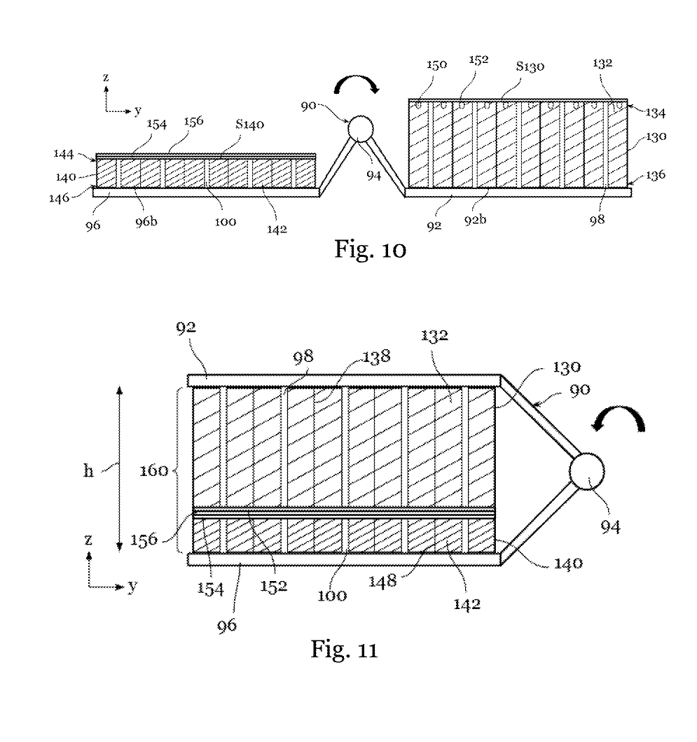

The tool 90, shown in FIG. 4b, is made up of first and second plates 92, 96 articulated together by articulation means 94. Here, the first and second plates 92, 96 are planar. The first and second plates 92, 96 are movable with respect to one another, via the articulation means 94, between a closed position (shown in FIG. 4b) and an open position (shown in FIG. 10). Each plate 92, 96 comprises a first face 92a, 96a, referred to as outer face, oriented toward the outside of the tool 90, and a second face 92b, 96b, referred to as inner face, oriented toward the inside of the tool 90, that is to say, toward the other of the plates 92, 96, when the tool 90 is in the closed position. In the open position of the tool 90, the first and second plates 92, 96 are arranged side by side and rest on their first face 92a, 96a. In the closed position of the tool 90, the first plate 92 is arranged above the second plate 96.

The honeycomb structure 80 is intended to be disposed between the first and second plates 92, 96, and more specifically between the second faces 92b, 96b, for the manufacture of the acoustic absorption structure. The first and second plates 92, 96 extend substantially parallel to one another when the honeycomb structure 80 is positioned between the plates 92, 96 (the tool 90 then being in the closed position). The first and second plates 92, 96 are substantially of the same dimensions (along the horizontal axes x and y) as the surface S of the honeycomb structure 80. Of course, the first and second plates 92, 96 may be of dimensions greater than those of the honeycomb structure 80.

The first plate 92 is provided with a plurality of first rods 98, of cylindrical shape with a circular base, extending from the second face 92b of the first plate 92 toward the inside of the tool 90 (when the tool 90 is in the closed position), that is to say, in a direction away from the first plate 92 or toward the second plate 96 (when the tool 90 is in the closed position), the first rods 98 being disposed so as to form a first comb.

The second plate 96 is provided with a plurality of second rods 100, of cylindrical shape with a circular base, extending from the second face 96b of the second plate 96 toward the inside of the tool 90 (when the tool 90 is in the closed position), that is to say, in a direction away from the second plate 96 or toward the first plate 92 (when the tool 90 is in the closed position), the second rods 100 being disposed so as to form a second comb.

According to one configuration, the number of first rods 98 of the first plate 92 is equal to the number of second rods 100 of the second plate 96. According to one configuration, the first rods 98 of the first plate 92 are disposed facing the second rods 100 of the second plate 96 when the tool 90 is in the closed position.

According to another configuration, the number of first rods 98 of the first plate 92 is different from the number of second rods 100 of the second plate 96. According to another configuration, the or some first rods 98 of the first plate 92 are disposed in different cells from the cells in which the second rods 100 of the second plate 96 extend when the tool 90 is in the closed position.

The first rods 98 of the first plate 92 have a height h1 (along the vertical axis z), whereas the second rods 100 of the second plate 96 have a height h2 (along the vertical axis z). The sum of the heights h1 and h2 is substantially equal to the height h. The heights h1 and h2 are each less than the height h, and may be identical to or different from one another, and depend on the desired height of the cells of the acoustic absorption structure obtained by this manufacturing method. The first and second rods 98, 100 are spaced apart from one another by a space e (along the vertical axis z) when the tool 90 is in the closed position, this space e being of negligible size with respect to the height h.

The method comprises a step E30 of installing the honeycomb structure 80 in the tool 90. The step E30 of installing the honeycomb structure 80 in the tool 90 comprises the following sub-steps:
a sub-step E31 of opening the tool 90 so as to make the second rods 100 of the second plate 96 accessible;
a sub-step E32 of inserting the honeycomb structure 80 onto the tool 90, and more specifically a sub-step of inserting the cells 82 of the honeycomb structure 80 onto the second rods 100 of the second plate 96; and
a sub-step E33 of closing the tool 90, during which the first rods 98 of the first plate 92 are inserted into the cells 82 of the honeycomb structure 80.

In other words, the tool 90 is put into its open position, then the honeycomb structure 80 is positioned on the second rods 100 of the second plate 96, the second rods 100 being inserted into cells 82 of the honeycomb structure 80 until the second end 86 of the honeycomb structure 80 comes into contact with the second face 96b of the second plate 96. The tool 90 is then closed, by means of the articulation means 94, such that the first rods 98 are inserted into cells 82 of the honeycomb structure 80 until the first end 84 of the honeycomb structure 80 comes into contact with the second face 92b of the first plate 92.

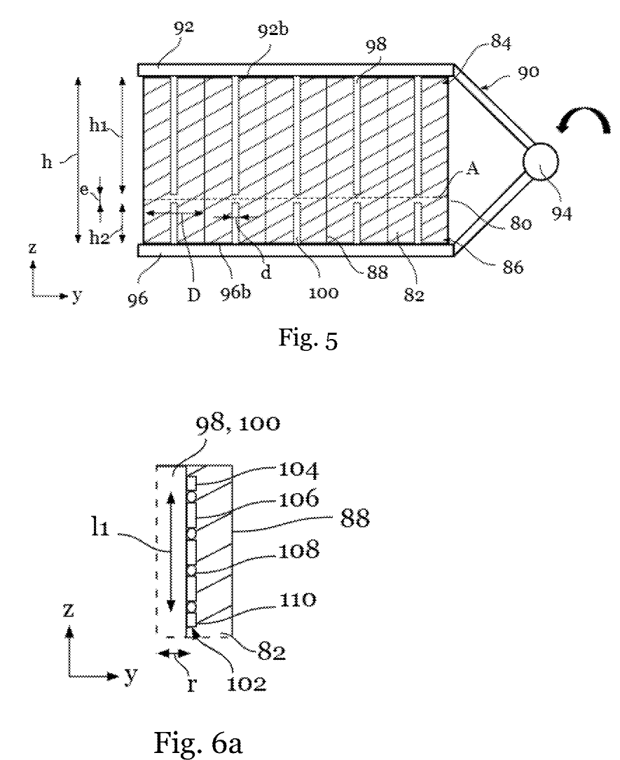

FIG. 5 shows the honeycomb structure 80 installed in the tool 90. The second end 86 of the honeycomb structure 80 is arranged against, that is to say, in contact with, the second face 96b of the second plate 96. The first end 84 of the honeycomb structure 80 is arranged against, that is to say, in contact with, the second face 92b of the first plate 92. The first and second rods 98, 100 extend in cells 82 of the honeycomb structure 80 and are centered with respect to the walls 88 of the cells 82. According to the configuration shown in FIG. 5, for each first rod 98 of the first plate 92 inserted into a cell 82, there is a second rod 100 of the second plate 96 disposed facing the first rod 98 of the first plate 92. Of course, the first rods 98 of the first plate 92 may be inserted into cells 82 in which there is no second rod 100 of the second plate 96. The honeycomb structure 80 has a height h, the first rods 98 have a height h1 less than the height h of the cells 82, and the second rods 100 have a height h2 less than the height h of the cells 82. In particular, the height h corresponds to the sum of the heights h1, h2 and of the space e (the size of the space e being negligible with respect to the height h).

The first and second rods 98, 100 are configured to be movable along the horizontal axes x and y, that is to say, the first and second rods 98, 100 are movable on the second face 92b, 96b of the first or second plate 92, 96. In other words, the position of the first and second rods 98, 100 is configured to be adjustable on the second face 92b, 96b of the first or second plate 92, 96 depending on the position of the cells 82 of the honeycomb structure 80. Thus, the first and second rods 98, 100 are adjustable along the horizontal axes x and y such that the first and second rods 98, 100 are optimally centered in the cells 82 of the honeycomb structure 80.

The first and second rods 98, 100 are configured to be adjustable in height with respect to the second face 92b, 96b of the first or second plate 92, 96. In other words, the height h1, h2 of the first and second rods 98, 100 is adjustable. For example, the first and second rods 98, 100 may be retractable with respect to the second face 92b, 96b of the first and second plates 92, 96, such that they may extend to a greater or lesser extent from the second face 92b, 96b of the first and second plates 92, 96. The first and second rods 98, 100 may thus be positioned at different heights in the cells 82 of the honeycomb structure 80. As shown in FIG. 5, the height h1 of the first rods 98 is greater than the height h2 of the second rods 100, but of course the situation could be reversed, depending on the desired configuration for the acoustic absorption structure, and the height h1 of the first rods 98 could be less than or equal to the height h2 of the second rods 100.

According to one configuration, the tool 90 comprises a first and second rod 98, 100 per cell 82. According to another preferred configuration, the tool 90 comprises a number of first and second rods less than the number of cells 82 of the honeycomb structure 80, so as to facilitate the insertion of the honeycomb structure 80 into the tool 90. For example, the tool 90 may comprise a first and second rod 98, 100 for each cell 82 of the honeycomb structure 80 that is positioned at a corner of the honeycomb structure 80, or for all the peripheral cells 82 of the honeycomb structure 80. Preferably, the tool 90 is not provided with first and second rods 98, 100 for each cell 82, and therefore not all the cells 82 of the honeycomb structure 80 receive first or second rods 98, 100 inserted therein.

The first and second rods 98, 100 have a diameter d smaller than the radial dimension D (in the plane containing the horizontal axes x and y) of a cell 82 when the first and second rods 98, 100 are inserted into the cells 82, so as to facilitate the insertion of the first and second rods 98, 100 into the honeycomb structure 80 and to compensate for any variation in size of the cells 82 of the honeycomb structure 80.

The method also comprises a step E40 of maintaining the position of the honeycomb structure 80 in the tool 90, by expanding the first and second rods 98, 100, so as to block a movement of the honeycomb structure 80 with respect to the tool 90, and therefore to secure the positioning of the honeycomb structure 80 on the tool 90.

The step E40 comprises a sub-step of radially expanding the first and second rods 98, 100, so as to ensure contact with the cell 82 and to lock the position of the honeycomb structure 80 with respect to the tool 90. The first and second rods 98, 100 are provided with means 102 for locking the position of the cells 82 into which the rods 98, 100 are inserted with respect to the tool 90. For example, the first and second rods 98, 100 are expandable, that is to say, at least part of the first and second rods 98, 100 has a variable diameter and can expand in the cells 82, so as to come into contact with the walls 88 of the cells 82. The locking means 102 then take the form of means 102 for radially expanding the first and second rods 98, 100. In particular, the first and second rods 98, 100 are configured to expand, by means of the locking means 102, and pass from a diameter d to a diameter equal to the radial dimension D of the cells 82.

### First configuration of the locking means

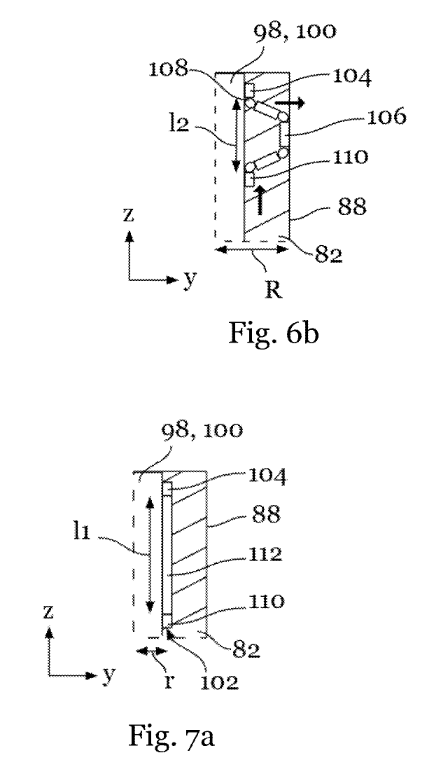

According to a first configuration shown in FIGS. 6a and 6b, each first and second rod 98, 100 comprises mechanically expandable locking means 102. The locking means 102 comprise a first ring 104 arranged around and fastened to the first or second rod 98, 100, a plurality of petals 106 articulated by articulations 108, and a second ring 110 arranged around the first or second rod 98, 100 and movable with respect to the fixed first ring 104. The articulated petals 106 are arranged between the fixed first ring 104 and the movable second ring 110, and connected to the rings 104, 110 by the articulations 108.

In the rest position of the locking means 102, shown in FIG. 6a, that is to say, prior to step E40, the locking means 102 are in contact with the first or second rod 98, 100. More specifically, the first and second rings 104, 110, the petals 106 and the articulations 108 are arranged in contact with the first or second rod 98, 100, and extend along part of the rod 98, 100 (along the vertical axis z). The fixed first ring 104 is spaced apart from the movable second ring 110 by a distance l1 (along the vertical axis z).

When the locking means 102 are activated, the movable second ring 110 is moved in translation (along the vertical axis z) in the direction of the fixed first ring 104, so as to bring the second ring 110 closer to the first ring 104. Since the petals 106 are fastened between the first and second rings 104, 110 by the articulations 108, they articulate under the effect of the translation of the second ring 110 and detach from the first or second rod 98, 100 so as to extend radially (along the horizontal axes x and y) in the cell 82 until the wall 88 of the cell 82 is reached.

In the activation position of the locking means 102, shown in FIG. 6b, that is to say, during step E40, the locking means 102 are only partially in contact with the first or second rod 98, 100. More specifically, only the first and second rings 104, 110, and possibly certain articulations 108, are arranged in contact with the first or second rod 98, 100. The petals 106 are detached from (that is to say, are no longer in contact with) the first or second rod 98, 100 and extend in the cell 82 in the direction of the wall 88 of the cell 82. At least one petal 106 is in contact with the wall 88 of the cell 82. The fixed first ring 104 is spaced apart from the movable second ring 110 by a distance l2 (along the vertical axis z) smaller than the distance l1.

Thus, in the activation position of the locking means 102, contact is ensured between the first and second rods 98, 100 of the tool 90 and the walls 88 of the cells 82 of the honeycomb structure 80, and this makes it possible to prevent a movement of the honeycomb structure 80 with respect to the tool 90 during the subsequent steps of the method.

The sub-step of radially expanding the first and second rods 98, 100 is calibrated to ensure that the honeycomb structure 80 is not damaged. The sub-step of radially expanding the first and second rods 98, 100 is also configured to be reversible.

### Second configuration of the locking means

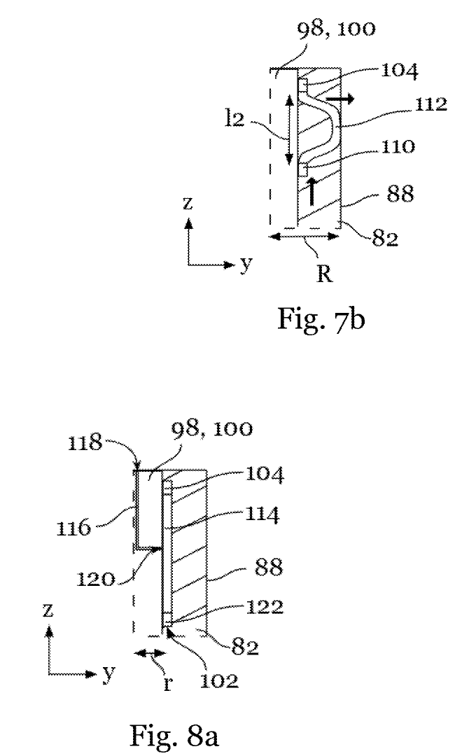

According to a second configuration shown in FIGS. 7a and 7b, each first and second rod 98, 100 comprises mechanically expandable locking means 102. The locking means 102 comprise a first ring 104 arranged around the first or second rod 98, 100 and fastened to the rod 98, 100, at least one elastomer bar 112, and a second ring 110 arranged around the first or second rod 98, 100 and movable with respect to the fixed first ring 104. The elastomer bar 112 is arranged between the fixed first ring 104 and the movable second ring 110, and connected to the rings 104, 110.

The elastomer bar 112 may be of annular shape and extend all the way around (around the entire circumference of) the first or second rod 98, 100, or else the first or second rod 98, 100 may be provided with at least one or a plurality of elastomer bars 112 around its circumference.

In the rest position of the locking means 102, shown in FIG. 7a, that is to say, prior to step E40, the locking means 102 are in contact with the first or second rod 98, 100. More specifically, the first and second rings 104, 110 and the elastomer bar 112 are arranged in contact with the first or second rod 98, 100, and extend along part of the rod 98, 100 (along the vertical axis z). The fixed first ring 104 is spaced apart from the movable second ring 110 by a distance l1 (along the vertical axis z).

When the locking means 102 are activated, the movable second ring 110 is moved in translation (along the vertical axis z) in the direction of the fixed first ring 104, so as to bring the second ring 110 closer to the first ring 104. Since the elastomer bar 112 is fastened between the first and second rings 104, 110, it articulates under the effect of the translation of the second ring 110 and detaches from the first or second rod 98, 100 so as to extend radially (along the horizontal axes x and y) in the cell 82 until the wall 88 of the cell 82 is reached.

In the activation position of the locking means 102, shown in FIG. 7b, that is to say, during step E40, the locking means 102 are only partially in contact with the first or second rod 98, 100. More specifically, only the first and second rings 104, 110, and possibly the ends of the elastomer bar 112, are arranged in contact with the first or second rod 98, 100. The elastomer bar 112 is detached from (that is to say, is no longer in contact with) the first or second rod 98, 100 and extends in the cell 82 in the direction of the wall 88 of the cell 82. Part of the elastomer bar 112 is in contact with the wall 88 of the cell 82. The fixed first ring 104 is spaced apart from the movable second ring 110 by a distance l2 (along the vertical axis z) smaller than the distance l1.

### Third configuration of the locking means

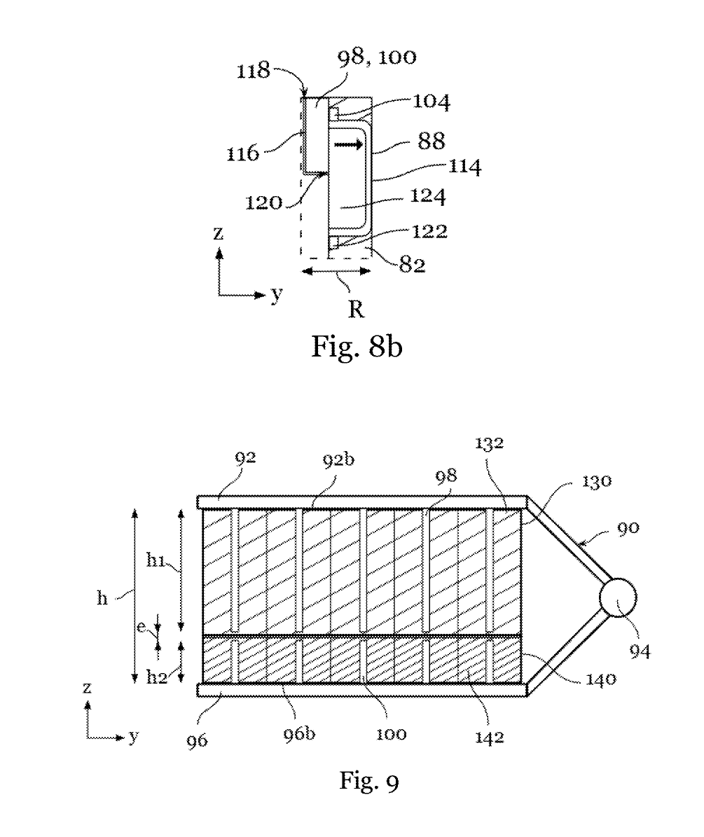

According to a third configuration shown in FIGS. 8a and 8b, each first or second rod 98, 100 comprises locking means 102 that are expandable fluidically (by means of compressed air). The locking means 102 comprise a first ring 104 arranged around the rod 98, 100 and fastened to the rod 98, 100, a flexible membrane 114, and a second ring 122 arranged around the rod 98, 100 and fastened to the rod 98, 100. The flexible membrane 114 is arranged between the fixed first and second rings 104, 122, and connected to the rings 104, 122. The flexible membrane 114 is of annular shape and extends all the way around (around the entire circumference of) the first or second rod 98, 100.

The first or second rod 98, 100 has a channel 116 for circulating a fluid, for example compressed air, comprising an inlet 118 arranged at an end of the first or second rod 98, 100 (at the second face 92b, 96b of the first or second plate 92, 96), and an outlet 120 opening out against the flexible membrane 114. The inlet 118 is connected to a pump (not shown in the figures) configured to send a pressurized fluid into the fluid circulation channel 116, or for example to a compressor (not shown in the figures) to send compressed air into the channel 116.

In the rest position of the locking means 102, shown in FIG. 8a, that is to say, prior to step E40, the locking means 102 are in contact with the first or second rod 98, 100. More specifically, the rings 104, 110 and the flexible membrane 114 are arranged in contact with the first or second rod 98, 100, and extend along part of the first or second rod 98, 100 (along the vertical axis z). No pressurized fluid circulates in the channel 116.

When the locking means 102 are activated, a pressurized fluid circulates in the channel 116, from the inlet 118 to the outlet 120, so as to fill the volume 124 defined between the flexible membrane 114 and the first or second rod 98, 100. Since this volume 124 is delimited by the first and second rings 104, 110, under the effect of the pressure exerted by the fluid, the flexible membrane 114 deforms radially (along the horizontal axes x and y) in the cell 82 and detaches from the first or second rod 98, 100 until the wall 88 of the cell 82 is reached. Once in position against the wall 88 of the cell 82, the circulation of the pressurized fluid in the channel 116 is interrupted, such that the volume 124 no longer increases, and is kept stable.

In the activation position of the locking means 102, shown in FIG. 8b, that is to say, during step E40, the locking means 102 are only partially in contact with the first or second rod 98, 100. More specifically, only the first and second rings 104, 110, and possibly the ends of the flexible membrane 114, are arranged in contact with the first or second rod 98, 100. The flexible membrane 114 is detached from (that is to say, is no longer in contact with) the first or second rod 98, 100 and extends in the cell 82 in the direction of the wall 88 of the cell 82. The flexible membrane 114 is separated from the first or second rod 98, 100 by the volume 124 of pressurized fluid. Part of the flexible membrane 114 is in contact with the wall 88 of the cell 82.

In FIGS. 6a, 7a and 8a, the radius r of the first and second rods 98, 100 is equal to half the initial diameter d of the rods 98, 100, and in FIGS. 6b, 7b and 8b, the radius R of the first and second rods 98, 100 is equal to half the radial dimension D of the cells 82.

Of course, other configurations of the locking means are possible without departing from the scope of the invention.

The method also comprises a step E50 of separating the honeycomb structure 80 into two parts, so as to form a first honeycomb substructure 130 comprising first cells 132 delimited by walls 138 and a second honeycomb substructure 140 comprising second cells 142 delimited by walls 148.

This step E50 can be carried out with means for separating the honeycomb structure 80, for example by means of a saw (not shown in the figures). Of course, any other separation means could be used. The separation means are inserted at the space e present between the first rods 98 and the second rods 100 when the tool 90 is in the closed position, and follow the horizontal cutting line A. The separation means thus have a thickness (along the vertical axis z) smaller than the space e. Since the honeycomb 80 is held in the tool 90 (after step E40), the separation means make it possible to separate the honeycomb structure 80 into two parts: a first “upper” part (above the space e, along the vertical axis z), which is held by the first rods 98 and which is secured to the first plate 92, and a second “lower” part (below the space e, along the vertical axis z), which is held by the second rods 100 and which is secured to the second plate 96. The first “upper” part of the honeycomb structure 80 corresponds to a first honeycomb substructure 130 with cells 132 of height h1, and the second “lower” part of the honeycomb structure 80 corresponds to a second honeycomb substructure 140 with cells 142 of height h2. The superposition of the first and second honeycomb substructures 130, 140 makes it possible to reform the honeycomb structure 80 of height h corresponding substantially to the sum of the heights h1 and h2.

During this separation step E50, as the first and second rods 98, 100 hold the honeycomb structure 80 with respect to the tool 90, the cells 132 of the first honeycomb substructure 130 are aligned above the cells 142 of the second honeycomb substructure 140 (superposed on the cells 142 of the second honeycomb substructure 140), and remain aligned after separation. The first rods 98 extend in the cells 132 of the first honeycomb substructure 130 and the second rods 100 extend in the cells 142 of the second honeycomb substructure 140.

The method then comprises a new step E60 of opening the tool 90, by means of the articulation means 94, such that the first plate 92 on which the first honeycomb substructure 130 is held is separated from the second plate 96 on which the second honeycomb substructure 140 is held. After opening of the tool 90, shown in FIG. 10, the first and second plates 92, 96 are side by side and are supported on their first face 92a, 96a. The first honeycomb substructure 130 has a first end 134, corresponding to the end of the honeycomb structure 80 that has been sawn, and a second end 136 resting on the first plate 92. The first honeycomb substructure 130 thus has, at its first end 134, a surface S130 (extending along the horizontal axes x and y) that is open during the separation step E50. The second honeycomb substructure 140 has a first end 144, corresponding to the end of the honeycomb structure 80 that has been sawn, and a second end 146 resting on the second plate 96. The second honeycomb substructure 140 thus has, at its first end 144, a surface S140 (extending along the horizontal axes x and y) that is open during the separation step E50.

Optionally, the method comprises a step E70 of drilling drainage holes 150 in at least one of the first or second honeycomb substructures 130, 140. In FIG. 10, drainage holes 150 are drilled in the surface S130, at the end 134 of the first honeycomb substructure 130. Of course, drainage holes may also be drilled in the surface S140, at the end 144 of the second honeycomb substructure 140. These drainage holes 150 allow the discharge of fluids from the acoustic absorption structure obtained by this method.

The method then comprises a step E80 of depositing adhesion means 152, 154 on the first and second honeycomb substructures 130, 140. For example, these adhesion means 152, 154 may take the form of an adhesive film 152 deposited on the entire surface S130 of the first honeycomb substructure 130 and an adhesive film 154 deposited on the entire surface S140 of the second honeycomb substructure 140. Of course, the adhesion means may take a form other than an adhesive film. For example, the adhesion means may cover only part of the surface S130, S140 of the first and second substructures 130, 140.

The method then comprises a step E90 of depositing a porous (perforated) partition 156 on one of the adhesion means 152, 154 of the first or second substructure 130, 140. In FIG. 10, the porous partition 156 is deposited on the adhesive film 154 of the surface S140 of the second honeycomb substructure 140. Of course, the porous partition 156 could be deposited on the adhesive film 152 of the surface S130 of the first honeycomb substructure 130. The porous partition 156 is a septum, and is continuous over the entire surface S130, S140 of the honeycomb substructure 130, 140.

The method then comprises a new step E100 of closing the tool 90, by means of the articulation means 94, such that the porous partition 156 is in contact with the adhesion means 152, 154 of the first and second honeycomb substructures 130, 140, in order to secure the first and second honeycomb substructures 130, 140 to the porous partition 156. The securing of the first and second honeycomb substructures 130, 140, shown in FIG. 11, makes it possible to obtain a double honeycomb structure 160 with a height h corresponding to the sum of the height h1 of the first honeycomb substructure 130, of the height h2 of the second honeycomb substructure 140 and of the thicknesses of the adhesive films 152, 154 and of the porous partition 156. The adhesion means 152, 154 are thus configured to secure the porous partition to the first and second honeycomb substructures 130, 140.

Optionally, depending on the adhesion means 152, 154 used above, the method then comprises a step E110 of finalizing the adhesion, during which the tool 90 comprising the double honeycomb structure 160 is placed in an oven or in an autoclave, so as to finalize the adhesion of the first and second honeycomb substructures 130, 140 to the porous partition 156, via the adhesion means 152, 154. The temperature of the oven or autoclave is increased to a predetermined temperature and maintained at this predetermined temperature for a predetermined duration to allow polymerization of the adhesion means 152, 154. This step thus makes it possible to polymerize the component of the adhesion means 152, 154 so as to fix the adhesion of the adhesion means 152, 154 to the first and second honeycomb substructures 130, 140 and to the porous partition 156.

The tool 90 thus makes it possible to maintain the position of the first honeycomb substructure 130 with respect to the second honeycomb substructure 140, after addition of the porous partition 156, so as to ensure alignment of the cells 132 of the first honeycomb substructure 130 with the cells 142 of the second honeycomb substructure 140.

Once the double honeycomb structure 160 has been assembled, the method comprises a step E120 of stopping maintaining the position of the double honeycomb structure 160 in the tool 90. This step E120 makes it possible to enable a movement of the double honeycomb structure 160 with respect to the tool 90.

The step E120 may comprise a sub-step of radially retracting the first and second rods 98, 100, so as to eliminate the contact between the first and second rods 98, 100 and the walls 138, 148 of the cells 132, 142 and to free up a movement of the double honeycomb structure 160 with respect to the tool 90.

For example, the locking means 102 are retracted, that is to say, the diameter of the first and second rods 98, 100 is reduced, so as to free up the movement of the cells 132, 142 with respect to the tool 90.

According to the first configuration of the locking means 102, during step E120, the movable second ring 110 is moved in translation (along the vertical axis z) in a direction away from the fixed first ring 104, so as to move the second ring 110 away from the first ring 104. Since the petals 106 are fastened between the first and second rings 104, 110 by the articulations 108, they articulate under the effect of the translation of the second ring 110 and detach from the walls 138, 148 of the cell 132, 142, in order to be positioned in contact with the first or second rod 98, 100, in the rest position.

According to the second configuration of the locking means 102, during step E120, the movable second ring 110 is moved in translation (along the vertical axis z) in a direction away from the fixed first ring 104, so as to move the second ring 110 away from the first ring 104. Since the elastomer bar 112 is fastened between the first and second rings 104, 110, it articulates under the effect of the translation of the second ring 110 and detaches from the walls 138, 148 of the cell 132, 142, in order to be positioned in contact with the first or second rod 98, 100, in the rest position.

According to the third configuration of the locking means 102, during step E120, the operation of the pump (not shown in the figures) configured to send a pressurized fluid into the volume 124 is reversed, such that the volume 124 defined between the flexible membrane 114 and the rod 98, 100 is reduced, until it is emptied, and this radially deforms (along the horizontal axes x and y) the flexible membrane 114 which detaches from the walls 138, 148 of the cell 132, 142, in order to be positioned in contact with the first or second rod 98, 100, in the rest position.

The method then comprises a new step E130 of opening the tool 90, so as to allow the double honeycomb structure 160 to come out of the tool 90.

The method comprises a step E140 of fastening a reflective layer 170 (which is impermeable, that is to say, non-perforated) to the end 164 of the double honeycomb structure 160, and a step E150 of fastening an acoustically resistive layer 180 (which is porous, that is to say, perforated) to the end 166 of the double honeycomb structure 160.

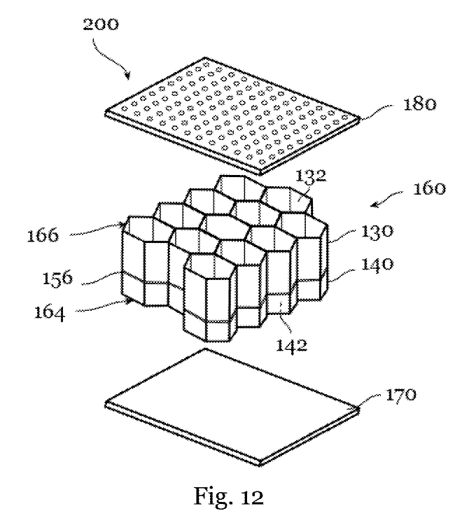

A DDOF acoustic absorption structure 200, shown in FIG. 12, is thus obtained. An acoustic absorption structure 200 obtained by this manufacturing method advantageously comprises cells 132, 142 which are aligned one above the other, and a porous partition 156 (septum) which is continuous over the entire acoustic absorption structure 200.

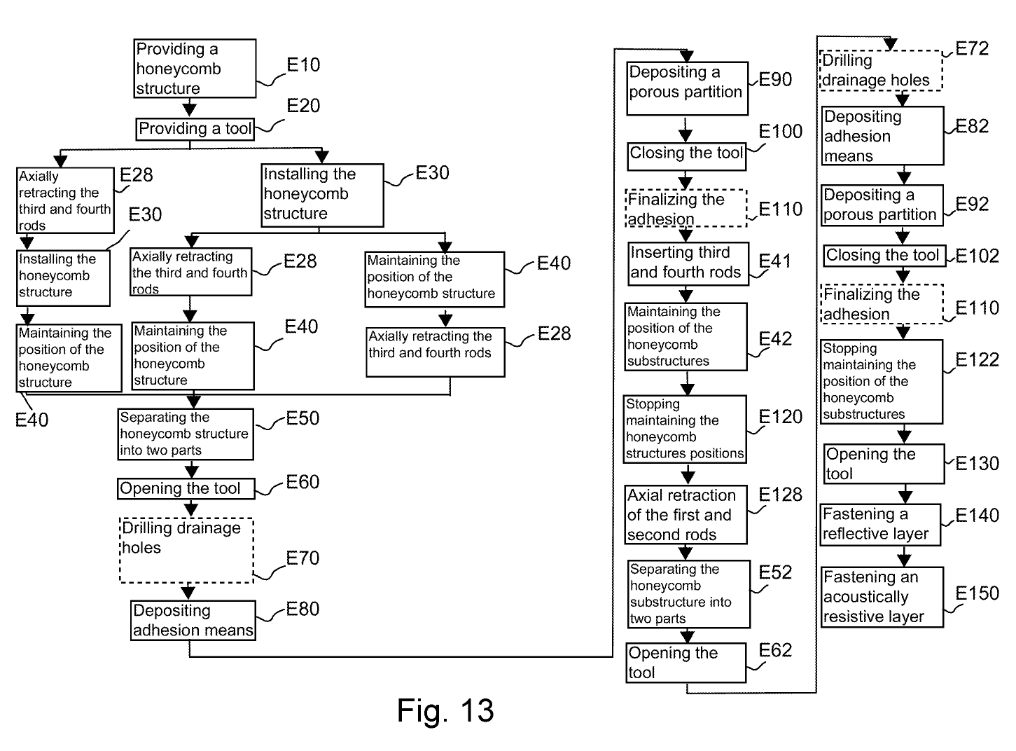

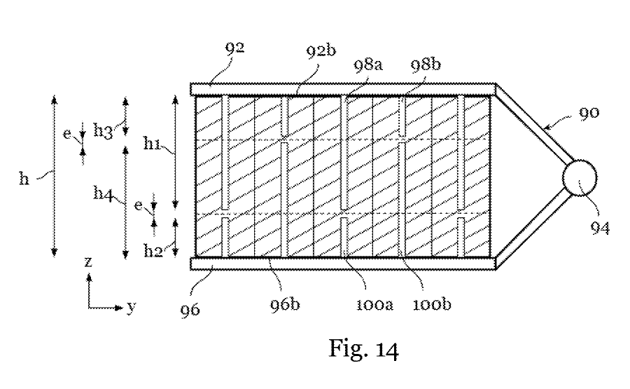

FIG. 13 shows the different steps of the method for manufacturing an MDOF acoustic absorption structure, by means of a tool 90, shown in FIG. 14.

With respect to the method for manufacturing the DDOF acoustic absorption structure in FIG. 3, only the differences are described for reasons of clarity, but different features described above are applicable.

The rods 98 of the first plate 92 are divided into two categories of rods: first rods 98a of height h1 (as described above) and third rods 98b of height h3, the height h3 being different from the height h1. The first rods 98a are disposed so as to form a first comb of height h1 and the third rods 98b are disposed so as to form a third comb of height h3. The first and third rods 98a, 98b alternate with respect to one another.

The rods 100 of the second plate 96 are divided into two categories of rods: second rods 100a of height h2 (as described above) and fourth rods 100b of height h4, the height h4 being different from the height h2. The second rods 100a are disposed so as to form a second comb of height h2 and the fourth rods 100b are disposed so as to form a fourth comb of height h4. The second and fourth rods 100a, 100b alternate with respect to one another.

In FIG. 13, the first rods 98a of the first plate 92 are disposed facing the second rods 100a of the second plate 96, whereas the third rods 98b of the first plate 92 are disposed facing the fourth rods 100b of the second plate 96 when the tool 90 is in the closed position. The first and second rods 98a, 100a thus form a first pair of rods 98a, 100a, and the third and fourth rods 98b, 100b thus form a second pair of rods 98b, 100b. Of course, the first rods 98a and the third rods 98b of the first plate 92 may not be disposed facing the second rods 100a and the fourth rods 100b of the second plate 96 when the tool 90 is in the closed position, but rather the rods 98a, 98b, 100a, 100b may extend in different cells 82 of the honeycomb structure 80.

The sum of the heights h1 and h2 is substantially equal to the height h, and the sum of the heights h3 and h4 is substantially equal to the height h. The heights h1, h2, h3 and h4 are each less than the height h, and may be identical to or different from one another, and depend on the desired height of the cells of the acoustic absorption structure obtained by this manufacturing method. The first and second rods 98a, 100a, and the third and fourth rods 98b, 100b, are spaced apart from one another by a space e (along the vertical axis z) when the tool 90 is in the closed position, this space e being of negligible size with respect to the height h.

As shown in FIG. 14, the rods 98a, 98b, 100a, 100b extend in cells 82 of the honeycomb structure 80. For each first rod 98a of the first plate 92 inserted into a cell 82, there is a second rod 100a of the second plate 96 disposed facing the first rod 98a of the first plate 92; and for each third rod 98b of the first plate 92 inserted into a cell 82, there is a third rod 100b of the second plate 96 disposed facing the third rod 98b of the first plate 92. In other words, a first pair of rods 98a, 100a is inserted into one cell 82, and a second pair of rods 98b, 100b is inserted into another cell 82. The honeycomb structure 80 has a height h, the first rods 98a have a height h1 less than the height h of the cells 82, the second rods 100a have a height h2 less than the height h of the cells 82, the third rods 98b have a height h3 less than the height h of the cells 82, and the fourth rods 100b have a height h4 less than the height h of the cells 82. In particular, the height h corresponds to the sum of the heights h1, h2 and of the space e (the size of the space e being negligible with respect to the height h), and the height h corresponds to the sum of the heights h3, h4 and of the space e.

The rods 98a, 98b, 100a, 100b are configured to be movable along the horizontal axes x and y, that is to say, the rods 98a, 98b, 100a, 100b are movable on the second face 92b, 96b of the first or second plate 92, 96. In other words, the position of the rods 98a, 98b, 100a, 100b is configured to be adjustable on the second face 92b, 96b of the first or second plate 92, 96 depending on the position of the cells 82 of the honeycomb structure 80. Thus, the rods 98a, 98b, 100a, 100b are adjustable along the horizontal axes x and y such that the rods 98a, 98b, 100a, 100b are optimally centered in the cells 82 of the honeycomb structure 80.

The rods 98a, 98b, 100a, 100b are configured to be adjustable in height with respect to the second face 92b, 96b of the first or second plate 92, 96. In other words, the height h1, h2, h3 and h4 of the first, second, third and fourth rods 98a, 100a, 98b, 100b is adjustable. For example, the rods 98a, 98b, 100a, 100b may be retractable with respect to the second face 92b, 96b of the first and second plates 92, 96, such that they may extend to a greater or lesser extent from the second face 92b, 96b of the first and second plates 92, 96. In particular, the rods 98a, 98b, 100a, 100b may be partially or totally retractable. The rods 98a, 98b, 100a, 100b may thus be positioned at different heights in the cells 82 of the honeycomb structure 80. As shown in FIG. 14, the height h1, h4 of the first and fourth rods 98a, 100b is greater than the height h2, h3 of the second and third rods 100a, 98b, but of course the situation could be reversed, depending on the desired configuration for the acoustic absorption structure, and the height h1, h4 of the first and fourth rods 98a, 100b could be less than or equal to the height h2, h3 of the second and third rods 100a, 98b.

According to one configuration, the tool 90 comprises a first and a second rod 98a, 100a (that is to say, a first pair of rods 98a, 100a) in every other cell 82, and a third and a fourth rod 98b, 100b (that is to say, a second pair of rods 98b, 100b) in the remaining alternating cells 82. In each cell 82, there is thus a first pair of first and second rods 98a, 100a, or a second pair of third and fourth rods 98b, 100b. According to another preferred configuration, the tool 90 comprises a number of pairs of rods 98a, 100a and 98b, 100b less than the number of cells 82 of the honeycomb structure 80, so as to facilitate the insertion of the honeycomb structure 80 into the tool 90. For example, the tool 90 may comprise a first or a second pair of rods 98a, 100a or 98b, 100b for all the peripheral cells 82 of the honeycomb structure 80 (different pairs of rods 98a, 100a and 98b, 100b being arranged in adjacent cells 82).

According to one configuration, the step E30 of installing the honeycomb structure 80 in the tool 90 comprises the following sub-steps:
opening the tool 90 so as to make the second rods 100a, and possibly the fourth rods 100b, of the second plate 96 accessible;
inserting the honeycomb structure 80 onto the tool 90, and more specifically inserting the cells 82 of the honeycomb structure 80 onto the second rods 100a, and possibly onto the fourth rods 100b, of the second plate 96; and
closing the tool 90, during which the first rods 98a, and possibly the third rods 98b, of the first plate 92 are inserted into the cells 82 of the honeycomb structure 80.

According to another configuration, prior to the step E30 of installing the honeycomb structure 80 in the tool 90, the method comprises a step E28 of axially retracting the third and fourth rods 98b, 100b (i.e., a step of axial translation along the vertical axis z), such that the installation of the honeycomb structure 80 in the tool 90 comprises:
opening the tool 90 so as to make the second rods 100a of the second plate 96 accessible;
inserting the cells 82 of the honeycomb structure 80 onto the second rods 100a of the second plate 96; and
closing the tool 90, during which the first rods 98a of the first plate 92 are inserted into the cells 82 of the honeycomb structure 80.

The method also comprises a first step E40 of maintaining the position of the honeycomb structure 80 in the tool 90, by expanding the first and second rods 98a, 100a (i.e., the first pair of rods 98a, 100a).

Prior to or after step E40, and prior to step E50, the method comprises a step E28 of axially retracting the third and fourth rods 98b, 100b, such that the third and fourth rods 98b, 100b no longer extend in the cells 82. For example, the height h3, h4 of the third and fourth rods 98b, 100b in the cells 82 is zero. Advantageously, when the second pairs of rods 98b, 100b are retracted axially after installation of the honeycomb structure 80 on the tool 90, this ensures that the second pairs of rods 98b, 100b are correctly disposed with respect to the cells 82 of the honeycomb structure 80, but the installation of the honeycomb structure 80 on the tool 90 may be more complex.

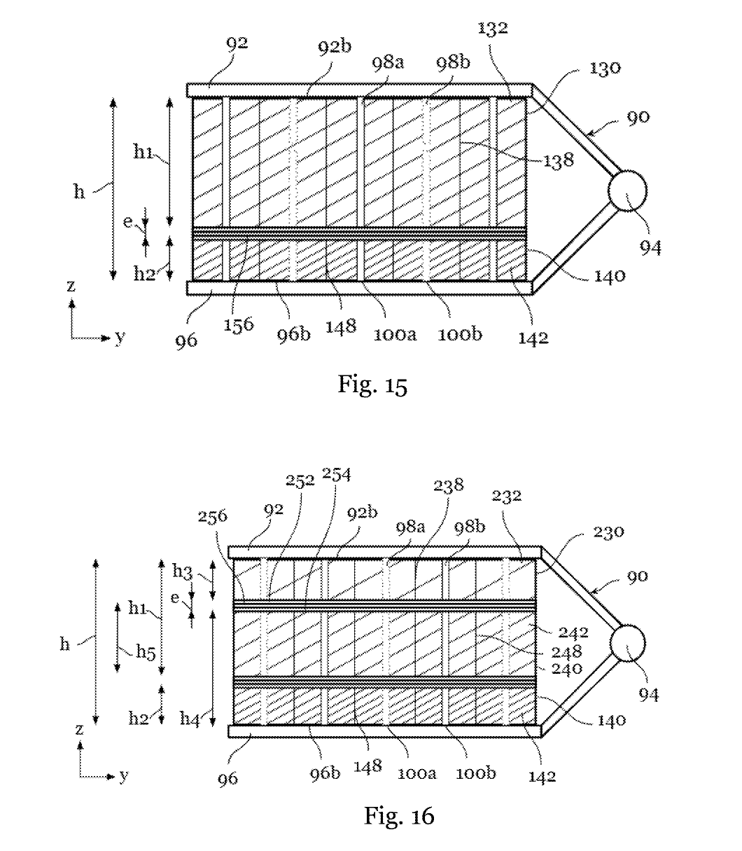

As shown in FIG. 15, the method also comprises a first step E50 of separating the honeycomb structure 80 into two parts, so as to form a first honeycomb substructure 130 comprising first cells 132 delimited by walls 138, and which is held by the first rods 98a and which is secured to the first plate 92, and a second honeycomb substructure 140 comprising second cells 142 delimited by walls 148, and which is held by the second rods 100a and which is secured to the second plate 96. During the first separation step E50, only the first pairs of rods 98a, 100a maintain the position of the cells 82, 132, 142 with respect to the tool 90, and the second pairs of rods 98b, 100b are retracted.

The method then comprises the step E60, optionally the step E70, then the step E80, the step E90 and the step E100, and optionally the step E110, as are described above.

The method then comprises a step E41 of inserting third and fourth rods 98b, 100b into the cells 132, 142 of the first and second honeycomb substructures 130, 140, during which the third and fourth rods 98b, 100b are moved in axial translation along the vertical axis z so as to take up position in the cells 132, 142.

According to one configuration, the height h4 of the fourth rods 100b is shaped so that the fourth rods 100b do not pass through the porous partition 156. For example, the fourth rods 100b have a height equal to h2. In this case, the fourth rods 100b extend only in the cells 142 of the second honeycomb substructure 140. The cells 132 of the first honeycomb substructure 130 are held only by the third rods 98b.

The method comprises a second step E42 of maintaining the position of the first and second honeycomb substructures 130, 140 in the tool 90, by expanding the third and fourth rods 98b, 100b (i.e., the second pair of rods 98b, 100b).

Once the first and second honeycomb substructures 130, 140 have been held on the tool by the second pairs of rods 98b, 100b, the method comprises a first step E120 of stopping maintaining the position of the first and second honeycomb substructures 130, 140 in the tool 90 by means of the first pair of rods 98a, 100a. The step E120 consists in radially retracting the first and second rods 98a, 100a.

The method then comprises a step E128 of axial retraction (i.e., vertical translation along the vertical axis z) of the first and second rods 98a, 100a, so as to remove the first and second rods 98a, 100a from the cells 132, 142 of the first and second substructures 130, 140.

The method comprises a second step E52 of separating, by means of separation means (not shown in the figures), the first honeycomb substructure 130 into two parts, so as to form a third honeycomb substructure 230 comprising third cells 232 delimited by walls 238 and a fourth honeycomb substructure 240 comprising fourth cells 242 delimited by walls 248. The fourth honeycomb substructure 240 is arranged between the second and third honeycomb substructures 140, 230.

As shown in FIG. 16, the third honeycomb substructure 230 comprises third cells 232, and is held by the third rods 98b and is secured to the first plate 92, and the fourth honeycomb substructure 240 comprises fourth cells 242, and is held by the fourth rods 100b, either directly or via the porous partition 156 which is bonded between the second and fourth honeycomb substructures 140, 240, and is secured to the second plate 96. During the second separation step E52, only the second pairs of rods 98b, 100b maintain the position of the cells 132, 142, 232, 242 with respect to the tool 90, and the first pairs of rods 98a, 100a are retracted.

The cells 232 have a height h3, and the cells 242 have a height h5 corresponding to the difference between the height h1 and the height h3. The sum of the heights h2, h3 and h5 is substantially equal to the height h. The superposition of the second, third and fourth honeycomb substructures 140, 230, 240 makes it possible to reform the honeycomb structure 80 of height h.

The method comprises a new step E62 of opening the tool 90, by means of the articulation means 94, such that the first plate 92 on which the third honeycomb substructure 230 is held is separated from the second plate 96 on which the second and fourth honeycomb substructures 140, 240 are held.

Optionally, the method comprises a step E72 of drilling drainage holes (not shown in the figures) in at least one of the third or fourth honeycomb substructures 230, 240.

The method comprises a step E82 of depositing adhesion means 252, 254 on the third and fourth honeycomb substructures 230, 240.

The method comprises a step E92 of depositing a porous (perforated) partition 256 on one of the adhesion means 252, 254 of the third or fourth honeycomb substructure 230, 240.

The method comprises a new step E102 of closing the tool 90, by means of the articulation means 94, in order to secure the third and fourth honeycomb substructures 230, 240 to the porous partition 256, via the adhesion means 252, 254, and to obtain a triple honeycomb structure comprising the second, third and fourth honeycomb substructures 140, 230, 240.

Optionally, depending on the adhesion means 152, 154, 252, 254 used above, the method then comprises a step E110 of finalizing the adhesion, during which the tool 90 comprising the triple honeycomb structure is placed in an oven or in an autoclave, so as to finalize the adhesion of the second, third and fourth honeycomb substructures 140, 230, 240 to the porous partitions 156, 256, via the adhesion means 152, 154, 252, 254.

The method then comprises a step E122 of stopping maintaining the position of the triple honeycomb structure in the tool 90. The step E122 makes it possible to enable a movement of the triple honeycomb structure with respect to the tool 90. The step E122 comprises radially retracting the third and fourth rods 98b, 100b, so as to eliminate the contact between the third and fourth rods 98b, 100b and the walls 148, 238, and optionally 248, of the cells 142, 232, and optionally 242, and to free up a movement of the triple honeycomb structure with respect to the tool 90.

The method then comprises a new step E130 of opening the tool 90, so as to allow the triple honeycomb structure to come out of the tool 90, then a step E140 of fastening a reflective layer 170 to the triple honeycomb structure, and a step E150 of fastening an acoustically resistive layer 180 to the triple honeycomb structure. An MDOF acoustic absorption structure is thus obtained.

Of course, MDOF acoustic absorption structures other than the one shown in the figures may be obtained by this manufacturing method without departing from the scope of the invention. In particular, the tool may be provided with a plurality of pairs of combs, which are able to be retracted or positioned at different steps of the method, depending on the number of honeycomb substructures desired for the acoustic absorption structure.

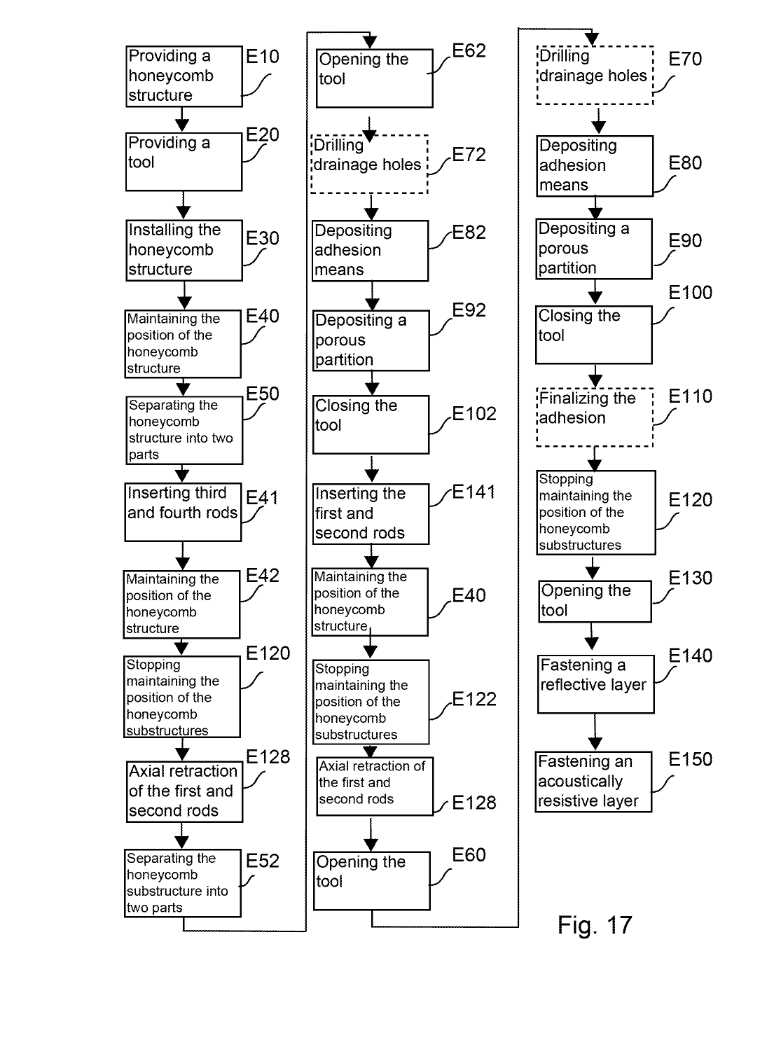

According to another configuration, instead of comprising a separation step E50, followed by a step E90 of inserting the porous partition 156, then a separation step E52, followed by a step E92 of inserting the porous partition 256, the method may comprise the separation steps E50, E52 one after the other, then the steps E90, E92 of inserting the porous partition 156, 256 one after the other. According to this configuration shown in FIG. 17, the method comprises, after the separation step E50:
a step E41 of inserting the third and fourth rods 98b, 100b into the cells 132, 142 of the first and second honeycomb substructures 130, 140,
a step E42 of maintaining the position of the first and second honeycomb substructures 130, 140 in the tool 90, by expanding the third and fourth rods 98b, 100b (i.e., the second pair of rods 98b, 100b),
a step E120 of stopping maintaining the position of the first and second honeycomb substructures 130, 140 in the tool 90 by means of the first pair of rods 98a, 100a (the first and second honeycomb substructures 130, 140 being held by the second pair of rods 98b, 100b),
a step E128 of axially retracting the first and second rods 98a, 100a, so as to remove the first and second rods 98a, 100a from the cells 132, 142 of the first and second substructures 130, 140,
a step E52 of separating the first honeycomb substructure 130 into two parts, so as to form third and fourth honeycomb substructures 230, 240,
a step E62, optionally a step E72, then a step E82, then a step E92 and a step E102, as are described above,
a new step E141 of inserting the first and second rods 98a, 100a into the cells 142, 232, 242 of the second, third and fourth honeycomb substructures 140, 230, 240,
a new step E40 of maintaining the position of the second, third and fourth honeycomb substructures 140, 230, 240 in the tool 90, by expanding the first and second rods 98a, 100a (i.e., the first pair of rods 98a, 100a),
a step E122 of stopping maintaining the position of the second, third and fourth honeycomb substructures 140, 230, 240 in the tool 90 by means of the second pair of rods 98b, 100b,
a step E128 of axially retracting the third and fourth rods 98b, 100b, so as to remove the third and fourth rods 98b, 100b from the cells 142, 232, 242 of the second, third and fourth honeycomb substructures 140, 230, 240,
a step E60, optionally a step E70, then a step E80, then a step E90 and a step E100, as are described above,
optionally, a step E110 of finalizing the adhesion of the adhesion means 152, 154, 252, 254 to the porous partitions 156, 256 and to the second, third and fourth honeycomb substructures 140, 230, 240,
a new step E120 of stopping maintaining the position of the second, third and fourth honeycomb substructures 140, 230, 240 in the tool 90 by means of the first pair of rods 98a, 100a,
a new step E130 of opening the tool 90, then a step E140 of fastening a reflective layer 170 to the triple honeycomb structure, and a step E150 of fastening an acoustically resistive layer 180 to the triple honeycomb structure.

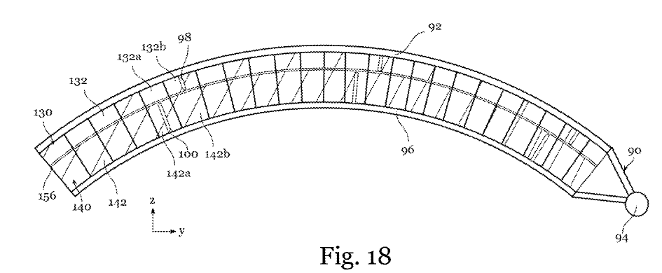

FIG. 18 shows another configuration of the tool 90. Here, the first and second plates 92, 96 are curved. More specifically, the first and second plates 92, 96 are of cylindrical shape, the base of which is a portion of a circle. For example, the first and second plates 92, 96 may be of conical shape.

The acoustic absorption structure obtained by the method according to the invention may be intended to be used in an aircraft nacelle. For this, the acoustic absorption structure will take the form of a wall of the nacelle against which it will be positioned, or take a form close to the shape of a wall of the nacelle against which it will be positioned: the acoustic absorption structure will be curved. With the tool 90 shown in FIG. 18, the acoustic absorption structure obtained will be curved, and will not need to be forced against the wall of the nacelle for installation thereof, or will not need to be forced as much against the wall of the nacelle for installation thereof.

Thus, the plates 92, 96 may have a shape substantially identical to the final shape of the acoustic absorption structure that is desired to be obtained.

In FIG. 18, the first and second rods 98, 100 are not arranged in cells 132, 142 of the first and second honeycomb substructures 130, 140 that are aligned (i.e. that face one another). The first honeycomb substructure 130 comprises adjacent cells 132a, 132b, and the second honeycomb substructure 140 comprises adjacent cells 142a, 142b, the cells 132a, 142a being aligned along an axis radial to the horizontal axis x (disposed facing one another), and the cells 132b, 142b being aligned radially to the horizontal axis x (disposed facing one another). The first rod 98 extends in the cell 132b of the first honeycomb substructure 130, whereas the second rod 100 extends in the cell 142a of the second honeycomb substructure 140. Thus, the pair of first and second rods 98, 100 extends in non-aligned cells 132, 142 of the first and second honeycomb substructures 130, 140. Of course, the first and second rods 98, 100 could extend in aligned cells 132, 142 of the first and second honeycomb substructures 130, 140.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A tool for manufacturing an acoustic absorption structure from a honeycomb structure comprising a plurality of cells of height h, comprising:
a first plate having a first inner face and a first outer face, and comprising a plurality of first rods extending from the first inner face over a height h1,
a second plate having a second inner face and a second outer face, and comprising a plurality of second rods extending from the second inner face over a height h2,
articulation means connected to the first and second plates,
the first plate being movable with respect to the second plate by means of the articulation means between an open position in which the first and second outer faces are disposed side by side and a closed position in which the first inner face is disposed facing the second inner face,
the first and second plates being shaped to receive the honeycomb structure therebetween, the first and second rods being configured to be inserted into the cells of the honeycomb structure,
a sum of the heights h1 and h2 being substantially equal to the height h, and
each of the first and second rods comprising means for radially expanding said first or second rods.

2. The tool as claimed in claim 1, for each first or second rod, the means for radially expanding said first or second rod being means for mechanically radially expanding said first or second rod.

3. The tool as claimed in claim 2, for each first or second rod, the means for radially expanding comprising a first ring fastened around said first or second rod, a second ring arranged around said first or second rod and a plurality of petals connected to the first and second rings by articulations, the second ring being configured to be movable in translation with respect to the first ring between a first position remote from the first ring in which the petals are in contact with said first or second rod and a second position close to the first ring in which the petals articulate and extend radially in a cell of the plurality of cells occupied by said first or second rod.

4. The tool as claimed in claim 2, for each first or second rod, the means for radially expanding comprising a first ring fastened around said first or second rod, a second ring arranged around said first or second rod and at least one elastomer bar connected to the first and second rings, the second ring being configured to be movable in translation with respect to the first ring between a first position remote from the first ring in which the elastomer bar is in contact with said first or second rod and a second position close to the first ring in which the elastomer bar deforms and extends radially in a cell of the plurality of cells occupied by said first or second rod.

5. The tool as claimed in claim 1, for each first or second rod, the means for radially expanding being means for fluidically radially expanding said first or second rod.

6. The tool as claimed in claim 5, for each first or second rod, the means for radially expanding comprising first and second rings fastened around said first or second rod and a flexible membrane connected to the first and second rings and defining a volume between the first and second rings and said first or second rod, the volume being configured to be filled with a pressurized fluid, the membrane being configured to deform and extend radially in a cell of the plurality of cells occupied by said first or second rod when the volume is filled with said pressurized fluid.

7. The tool as claimed in claim 1:
the first plate also comprising a plurality of third rods extending from the first inner face over a height h3,
the second plate also comprising a plurality of fourth rods extending from the second inner face over a height h4,
the third and fourth rods being configured to be inserted into the cells of the honeycomb structure,
a sum of the heights h3 and h4 being substantially equal to the height h,
each of the third and fourth rods comprising means for radially expanding said third or fourth rod, and
the first, second, third and fourth rods being retractable.

8. The tool as claimed in claim 1, the first and second plates being planar or curved.

9. A method for manufacturing an acoustic absorption structure by means of a tool as claimed in claim 1, comprising:
a step of installing the honeycomb structure in the tool such that the first and second rods are inserted into the cells of the honeycomb structure,
a step of maintaining a position of the cells of the honeycomb structure in the tool, by expanding the means for radially expanding the first and second rods,
a step of separating the honeycomb structure into a first honeycomb substructure comprising first cells and a second honeycomb substructure comprising second cells,
a step of fastening a porous partition between the first and second honeycomb substructures,
a step of stopping maintaining the position of the cells of the first and second honeycomb substructures in the tool, by radially retracting the means for radially expanding the first and second rods,
a step of fastening a reflective layer to the second honeycomb substructure, and
a step of fastening an acoustically resistive layer to the first honeycomb substructure.

10. The method as claimed in claim 9, comprising, prior to the step of fastening the porous partition, a step of drilling drainage holes in at least one of the first or second honeycomb substructures.
